(19) United States
(12) Patent Application Publication
(10) Pub. No.: US 2011/0161869 A1
(43) Pub. Date: Jun. 30, 2011

(54) APPARATUS AND METHOD FOR DISPLAYING GRAPHICAL USER INTERFACE IN DIGITAL IMAGE PROCESSING APPARATUS

(75) Inventors: Jeoung-gon Yoo, Suwon-si (KR); Sung-ho Eun, Seoul (KR)

(73) Assignee: Samsung Electronics Co., Ltd., Suwon-si (KR)

(21) Appl. No.: 12/964,885

(22) Filed: Dec. 10, 2010

(30) Foreign Application Priority Data
Dec. 24, 2009 (KR) 10-2009-0130790

(51) Int. Cl. G06F 3/048

(52) U.S. Cl. 715/798; 715/799

(57) ABSTRACT

A method and digital image processing apparatus for outputting a graphical user interface (GUI), the apparatus including: a graphical user interface (GUI) display device; and a digital signal processor (DSP) configured to reposition a GUI according to display information received from an external display device or a received selection signal and configured to output the repositioned GUI to the external display device. The digital image processing apparatus may be configured to connect to the external display device.

### CROSS-REFERENCE TO RELATED PATENT APPLICATION

This application claims the benefit of Korean Patent Application No. 10-2009-0130790, filed on Dec. 24, 2009, in the Korean Intellectual Property Office, the entire disclosure of which is incorporated herein by reference.

### BACKGROUND

1. Field of the Invention

The invention relates to an apparatus and method for digital image processing, and more particularly, to an apparatus and method for displaying a graphical user interface (GUI) on a digital image processing apparatus in which a GUI to be output is repositioned or resized.

2. Description of the Related Art

Often, when an external display device is connected to a digital image processing apparatus and an image from the digital image processing apparatus is output to the external display device, the image and a graphical user interface (GUI) are output at fixed sizes.

For example, if the external display device is a TV, an image display size may be fixed at a resolution of VGA 640×480. FIG. 11A illustrates a GUI that is output on a screen having a resolution of VGA 640×480. However, as illustrated in FIG. 11B, the GUI may be cropped at an upper, lower, left, or right side of the display device.

### SUMMARY

Therefore there is a need in the art for a method and a digital image processing apparatus, the apparatus including a graphical user interface (GUI) display device; and a digital signal processor (DSP) configured to reposition a GUI according to display information received from an external display device and configured to output the repositioned GUI to the external display device, wherein the digital image processing apparatus is configured to connect to the external display device.

The DSP may include an information receiving unit configured to receive the display information from the external display device; a storage unit configured to store basic GUI position information and GUI reposition information corresponding to at least one piece of the received display information; and a control unit configured to search for GUI reposition information corresponding to the received display information stored in the storage unit, and configured to reposition the GUI according to found GUI reposition information, and configured to output the repositioned GUI to the external display device.

The display information of the external display device may include information indicating a manufacturer of the external display device, information indicating an output resolution of the external display device, and information indicating a broadcasting standard of the external display device.

The control unit may be configured to search the storage unit using two or more pieces of the received display information according to priorities assigned thereto to reposition the GUI.

A digital image processing apparatus is disclosed. The apparatus including a graphical user interface (GUI) display device; and a digital signal processor (DSP) configured to resize a GUI according to a selection signal and configured to output the repositioned GUI to the external display device, wherein the digital image processing apparatus is configured to connect to the external display device.

The DSP including a resizing unit configured to resize the GUI; and

a control unit configured to control the resizing unit to resize the GUI to fit on the external display device in response to the size adjustment selection signal.

The resized GUI may be positioned in multiple positions on the external display device.

A digital image processing apparatus is disclosed. The apparatus including a graphical user interface (GUI) display device; and a digital signal processor (DSP) configured to resize a GUI according to display information received from the external display device and configured to output the resized GUI to the external display device, wherein the digital image processing apparatus is configured to connect to the external display device.

The DSP including an information receiving unit configured to receive display information from the external display device; a storage unit configured to store basic GUI size information and GUI size change information corresponding to at least one piece of the received display information; a resizing unit configured to resize the GUI; and a control unit configured to search in the storage unit for GUI screen size information corresponding to the received display information, and configured to control resizing of the GUI according to GUI size change information, and configured to output the resized GUI to the external display device.

The display information of the external display device may include information indicating a manufacturer of the external display device, information indicating an output resolution of the external display device, and information indicating a broadcasting standard of the external display device.

The control unit may be configured to search the storage unit for two or more pieces of the received display information according to priorities assigned thereto to reposition the GUI.

The resized GUI can may be positioned in different places on the external display device.

A method of displaying a graphical user interface (GUI) on a digital image processing apparatus is disclosed. The method including connecting to an external display device; receiving display information from the external display device; searching for GUI reposition information corresponding to the received display information in a storage unit in which is stored GUI position information of the GUI and GUI reposition information corresponding to at least one piece of the display information; and repositioning the GUI according to found GUI reposition information and outputting the GUI on the external display device.

The display information of the external display device may include information indicating a manufacturer of the external display device, information indicating an output resolution of the external display device, and information indicating a broadcasting standard of the external display device.

The control unit may search the storage unit for two or more pieces of the display information according to priorities assigned thereto to reposition the GUI.

A method of displaying a graphical user interface (GUI) on a digital image processing apparatus is disclosed. The method includes connecting to an external display device; displaying the GUI on the external display device; receiving a signal for resizing the GUI displayed on the external display device; and resizing the GUI according to the received signal and displaying the resized GUI.

The resized GUI screen may be positioned in different positions on the external display device.

A method of displaying a graphical user interface (GUI) on a digital image processing apparatus is disclosed. The method including connecting to an external display device; receiving display information from the external display device; searching for size information for resizing the GUI corresponding to the received display information; and resizing of the GUI according to size information for resizing the GUI, and outputting the GUI on the external display device.

The received display information of the external display device may include information indicating a manufacturer, information indicating an output resolution, and information indicating broadcasting standards; and wherein searching further comprises: searching in a storage unit with respect to two or more pieces of the display information according to priorities assigned thereto to reposition the GUI.

The resized GUI screen may be positioned in different positions on the external display device.

### BRIEF DESCRIPTION OF THE DRAWINGS

The above and other features and advantages of embodiments of the invention will become more apparent by describing in detail exemplary embodiments thereof with reference to the attached drawings in which:

FIG. 1 is a block diagram illustrating a graphical user interface (GUI) display device in a digital image processing apparatus according to an embodiment of the invention;

FIG. 2 is a detailed diagram illustrating a digital signal processor (DSP) of FIG. 1 according to an embodiment of the invention;

FIG. 3 illustrates position information of a basic GUI stored in a storage unit of FIG. 2;

FIG. 4A through 4D illustrate a data table of position information of a basic GUI stored in the storage unit of FIG. 2 and data tables for repositioning the GUI;

FIG. 5 is a detailed diagram illustrating the DSP of FIG. 1 according to another embodiment of the invention;

FIG. 6A through 6D illustrate a GUI changed by the DSP of FIG. 2;

FIG. 7 is a detailed diagram illustrating the DSP of FIG. 1 according to another embodiment of the invention;

FIG. 8 is a flowchart illustrating a method of displaying a GUI that may be performed by the DSP of FIG. 2;

FIG. 9 is a flowchart illustrating a method of displaying a GUI in the DSP of FIG. 5;

FIG. 10 is a flowchart illustrating a method of displaying a GUI in the DSP of FIG. 7; and

FIG. 11 illustrates a GUI according to the prior art.

### DETAILED DESCRIPTION

The invention will now be described more fully with reference to the accompanying drawings, in which exemplary embodiments of the invention are shown.

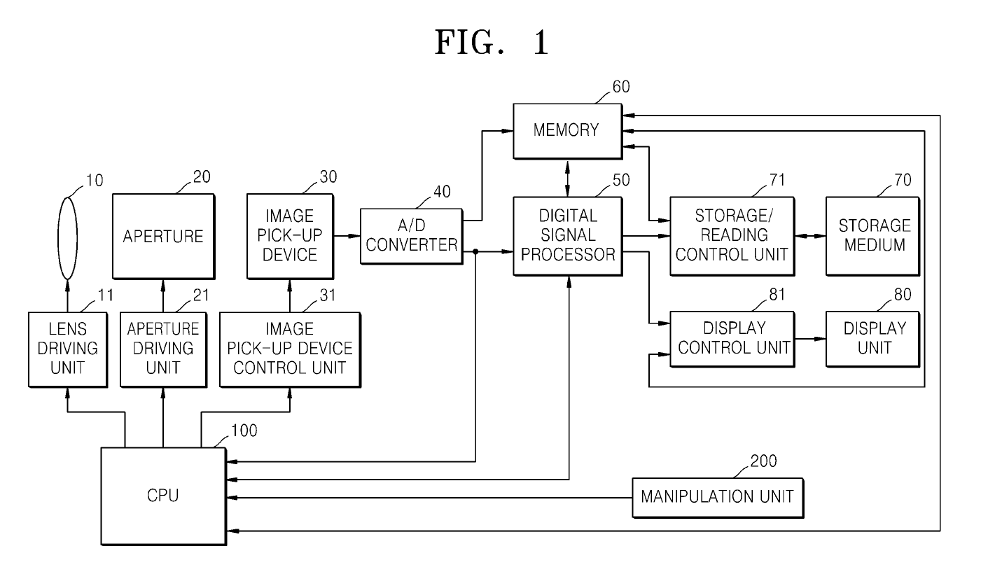

FIG. 1 is a block diagram illustrating a graphical user interface (GUI) display device in a digital image processing apparatus according to an embodiment of the invention. In detail, a digital photographing apparatus that may adjust a GUI is illustrated in FIG. 1. However, the digital image processing apparatus is not limited thereto as in FIG. 1 and may also be an image processing apparatus such as a personal digital assistant (PDA), a personal multimedia player (PMP), etc. This applies also to embodiments to be described later and modified examples thereof.

The overall operation of the digital image processing apparatus is controlled by a CPU 100. The digital image processing apparatus includes a manipulation unit 200 including keys that generate electric signals when manipulated by a user. An electric signal from the manipulation unit 200 is transmitted to the CPU 100 to control the digital image processing apparatus.

In a photographing mode, as the electrical signal from the manipulation unit is transmitted to the CPU 100, the CPU 100 controls a lens driving unit 11, an aperture driving unit 21, and an image pick-up device control unit 31 according to the electrical signal, and accordingly, positioning of lenses 10, an aperture degree of an aperture 20, and sensitivity of an image pick-up device 30 are controlled. The image pick-up device 30 generates data from light incident thereon, and an analog/digital converter 40 converts analog data output from the image pick-up device 30 to digital data. Obviously, the analog/digital converter 40 may not be necessary according to the characteristics of the image pick-up device 30.

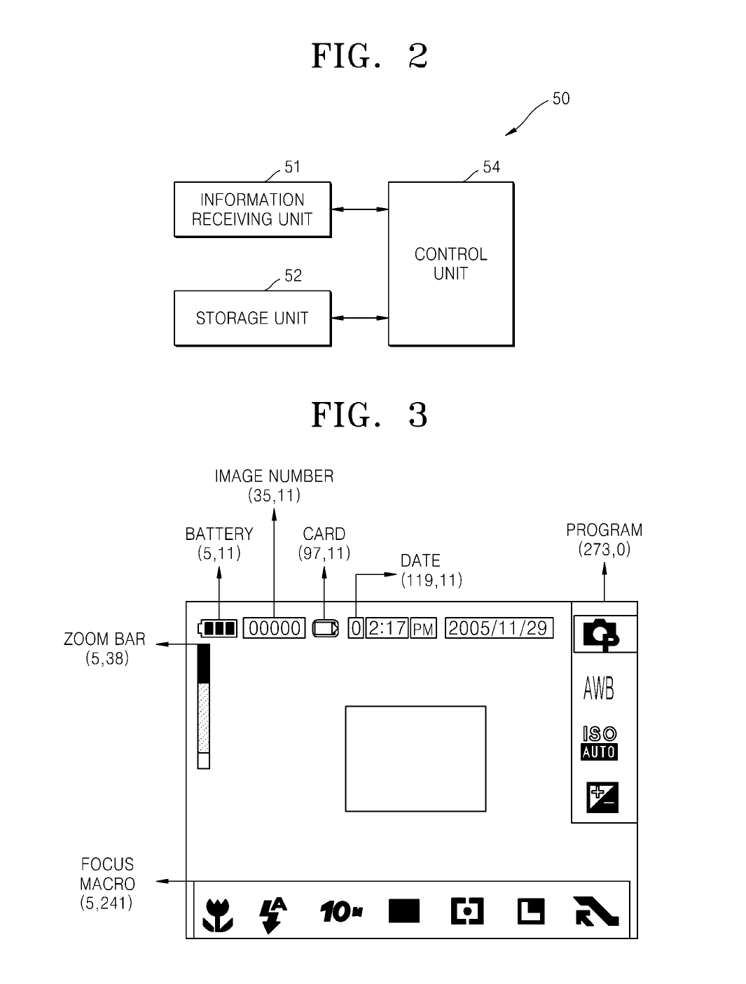

Data transmitted from the image pick-up device 30 may be input to the digital signal processor 50 directly or via a memory 60, or to the CPU 100 according to necessity. The memory 60 may be a read only memory (ROM) or a random access memory (RAM). A digital signal processor (DSP) 50 may perform digital signal processing such as gamma correction, white balance modification, and the like. Also, as illustrated in FIGS. 2, 5, and 7, the DSP 50 may include elements such as a data receiving unit 51, a storage unit 52, a resizing unit 53, and a control unit 54. The data receiving unit 51, the storage unit 52, the resizing unit 53, and the control unit 54 may be elements separate from the DSP 50 instead of being elements in the DSP 50, and operations thereof will be described later.

Image data output from the DSP 50 may be transmitted to a display control unit 81 directly or via the memory 60. The display control unit 81 controls a display unit 80 to display an image. According to the current embodiment of the invention, the display unit 80 may be a touch screen. Data output from the DSP 50 may be input to a storage/reading control unit 71 directly or via the memory 60. The storage/reading control unit 71 may store image data in a storage medium 70, according to a signal transmitted from the manipulation unit 200 or automatically. Also, the storage/reading control unit 71 may read data from an image file stored in the storage medium 70 and transmit the data to the display control unit 81 via the memory 60 or another path so as to display an image on the display unit 80. The storage medium 70 may be detachable or be permanently mounted on the digital image processing apparatus.

Hereinafter, operations of the DSP 50 will be described with reference to FIGS. 2 through 7.

According to a first embodiment of the invention, the DPS 50 will be described with reference to FIG. 2. The DSP 50 repositions GUI icons according to display information received from an external display device and then outputs the repositioned GUI icons. To this end, the DSP 50 includes the data receiving unit 51, the storage unit 52, and the control unit 54.

The information receiving unit 51 receives display information from an external display device that is connected to the digital image processing apparatus (e.g., a TV). The display information of the external display device received by the information receiving unit 51 may be information indicating an output resolution of the external display device (e.g., VGA 640×480), information indicating a manufacturer of the external display device (e.g., S corporation or L corporation), information indicating a broadcasting standard of the external display device (e.g., NTSC, PAL), etc. The information receiving unit 51 receives the display information of the external display device via an image transmission path or any of other paths.

The storage unit 52 stores position information of basic GUI icons and reposition information for GUI icons corresponding to at least one piece of the display information of the external display device.

FIG. 3 illustrates basic GUI icons and position information thereof displayed on the display unit 80 of the digital image processing apparatus. The basic GUI icons provided by the digital image processing apparatus may be a battery icon, an image number icon, a card icon, a zoom bar icon, and the like, and the GUI icons are positioned on a boundary of the display unit 80.

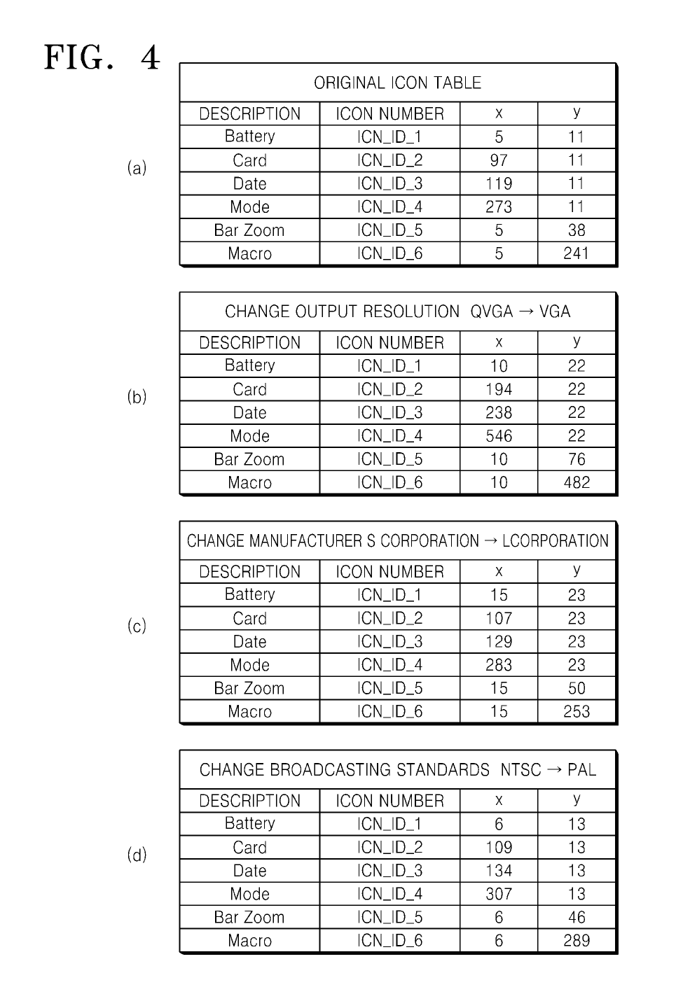

FIGS. 4A through 4D illustrate a position data table for the basic GUI icons stored in the storage unit 52 and reposition data tables for the basic GUI icons. Each data table consists of descriptions of the GUI icons, numbers of the GUI icons, and x and y coordinates positions.

In detail, FIG. 4A is a data table in which the position information of the basic GUI icons, that is, positions of the GUI icons, corresponding to the digital image processing apparatus is stored. The position information may correspond to the digital image processing apparatus having a basic output resolution of QVGA (320×240), manufactured by S company, and using NTSC. For example, in the case of the battery icon, its icon number is stored as “ICN_ID_{—}1”, and its x-coordinate is stored as 5, and its y coordinate is stored as 11.

FIG. 4B is a data table in which is stored reposition information for the GUI icons for when an output resolution of the external display device, for example, VGA(640×480), is different from the output resolution of the digital image processing apparatus, that is, QVGA (320×240). For example, in the case of the battery icon, when changed from an output resolution of QVGA(320×240) to an output resolution of VGA(640×480), its x coordinate is 10 and its y coordinate is 22.

FIG. 4C is a data table in which is stored reposition information for the GUI icons for when a manufacturer of the external display device, for example, L corporation, is different from the manufacturer of the digital image processing apparatus, that is, S corporation. For example, in the case of the battery icon, when changed from S corporation to L corporation, its x coordinate is changed to 15 and its y coordinate is changed to 23.

FIG. 4D is a data table in which is stored reposition information for the GUI icons for when a broadcasting standard of the external display device, for example, PAL, is different from the broadcasting standard of the digital image processing apparatus, that is, NSTC. For example, in the case of the battery icon, when changed from NSTC to PAL, its x coordinate is changed to 6 and its y coordinate is changed to 13.

The control unit 54 searches for the reposition information for the GUI icons corresponding to the display information received by the information receiving unit 51 from the storage unit 52 and repositions and displays the GUI icons on the external display device. The information receiving unit 51 searches for a data table corresponding to the received display information from among the data tables of FIGS. 4A through 4D, and repositions each of the GUI icons according to the reposition information stored in the corresponding data table. If there are two or more data tables corresponding to the received display information existing in the storage unit 52, the control unit 54 assigns priorities to the data tables. For example, if the received display information includes information indicating that the external display device has a VGA output resolution, information indicating that the external display device is manufactured by L corporation, and information indicating that the external display device uses PAL, higher priority may be assigned to the information indicating the manufacturer, and thus the reposition information in the data table of FIG. 4C may be used for repositioning the GUI icons. The priority is not fixed and may be set according to the user.

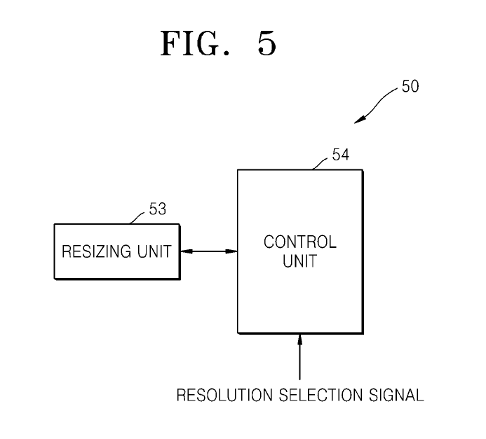

According to a second embodiment of the invention, the DSP 50 will be described with reference to FIG. 5. When an external display device is connected to the digital image processing apparatus, the user may input a size adjustment signal while viewing the displayed GUI on the external display device, the DSP 50 resizes the GUI and outputs the GUI according to the size adjustment signal. Compared to the embodiment of FIG. 2, while the GUI icons may be repositioned according to display information of an external display device, according to the current embodiment, the GUI may be resized. To this end, the DSP 50 includes the resizing unit 53 and the control unit 54.

The resizing unit 53 resizes a basic GUI to any of various sizes. a GUI generally have a size corresponding to a screen resolution of QVGA (320×240), but may be resized to another size, for example, VGA(640×480).

The control unit 54 controls resizing performed by the resizing unit 53 in response to the size adjustment selection signal input by the user, so that the GUI may be sized to be included within the external display device. The resized GUI may be moved to a center, to a lower right end, or to a right side of a screen of the external display device.

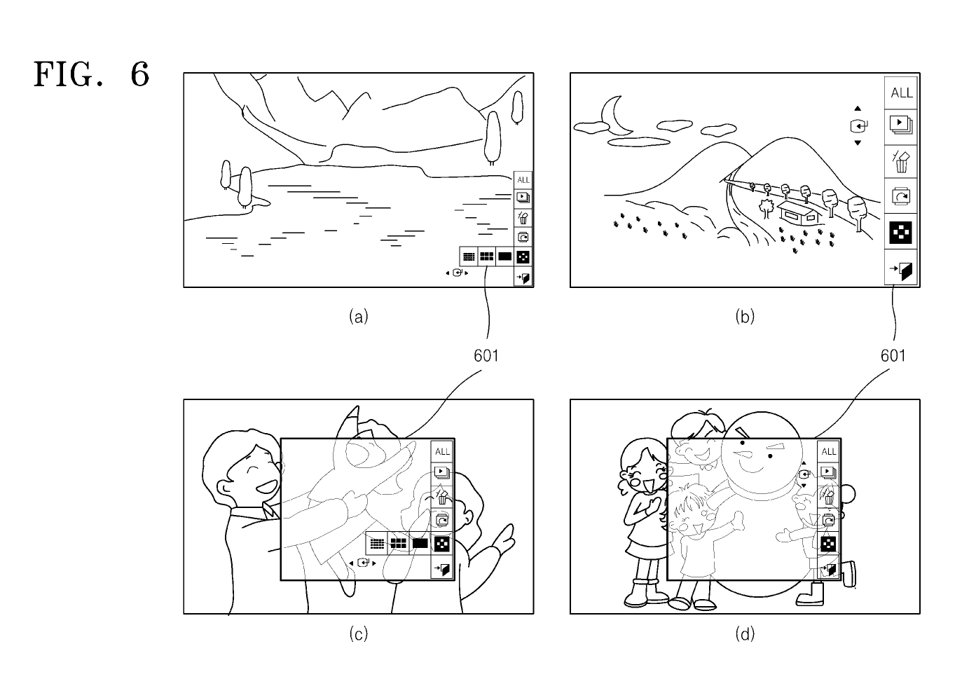

FIGS. 6A through 6D illustrate a resized GUI 601 displayed on a screen of an external display device. In FIG. 6A, the resized GUI 601 is positioned at a lower right end of the screen. In FIG. 6B, the resized GUI 601 is positioned on a right side of the screen. In FIGS. 6C and 6D, the resized GUI 601 is positioned at a center of the screen of the external display device.

The user may reposition and resize the GUI 601 while viewing the GUI 601 displayed on the screen of the external display device. The control unit 54 repositions and resizes the GUI 601 in response to a signal input by the user for repositioning and resizing the GUI 601 and outputs the adjusted GUI screen 601 to the external display device.

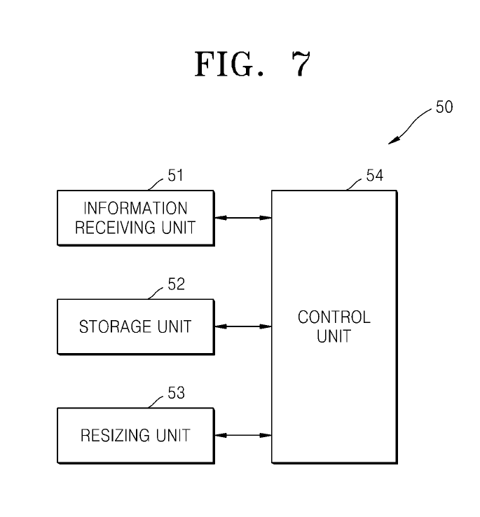

According to a third embodiment of the invention, the DSP 50 will be described with reference to FIG. 7. The DSP 50 resizes a basic GUI according to display information received from an external display device and then outputs the GUI. Compared to the previous embodiments, wherein each of GUI icons are repositioned according to the display information of the external display device in the embodiment of FIG. 2, and wherein the GUI is resized in the embodiment of FIG. 5, resizing information of the GUI is stored in a storage unit in the current embodiment. Thus, the GUI is resized according to the display information received from the external display device. To this end, the DSP 50 includes the information receiving unit 51, the storage unit 52, the resizing unit 53, and the control unit 54.

The information receiving unit 51 receives the display information from the external display device connected to the digital image processing apparatus. Examples of the display information received by the information receiving unit 51 are information indicating an output resolution of the external display device, information indicating a manufacturer of the external display device, and information indicating a broadcasting standard of the external display device. The information receiving unit 51 receives the display information of the external display device via an image transmission path or any of other paths.

The storage unit 52 stores basic GUI screen information and GUI resizing information corresponding to at least one piece of the display information.

The resizing unit 53 resizes the basic GUI to another size according to the GUI resizing information stored in the storage unit 52.

The control unit 54 searches for the GUI resizing information corresponding to the display information received by the information receiving unit 51, from the storage unit 52, to resize the GUI and then resizes and outputs the same on the external display device. If there are two or more pieces of resizing information corresponding to the received display information, the control unit 54 assigns priorities thereto. For example, when the received display information are information indicating that the external display device has a VGA output resolution, information indicating that the external display device is manufactured by L corporation, and information indicating that the external display device uses PAL, higher priority may be assigned to the information indicating the manufacturer, and the GUI is resized according to resizing information corresponding to the manufacturer. The priority is not fixed and may be set according to the user.

Also, the control unit 54 repositions the GUI in response to a position adjustment signal input by the user. The resized GUI may be moved to a center, a lower end, or a right side of a screen of the external display device.

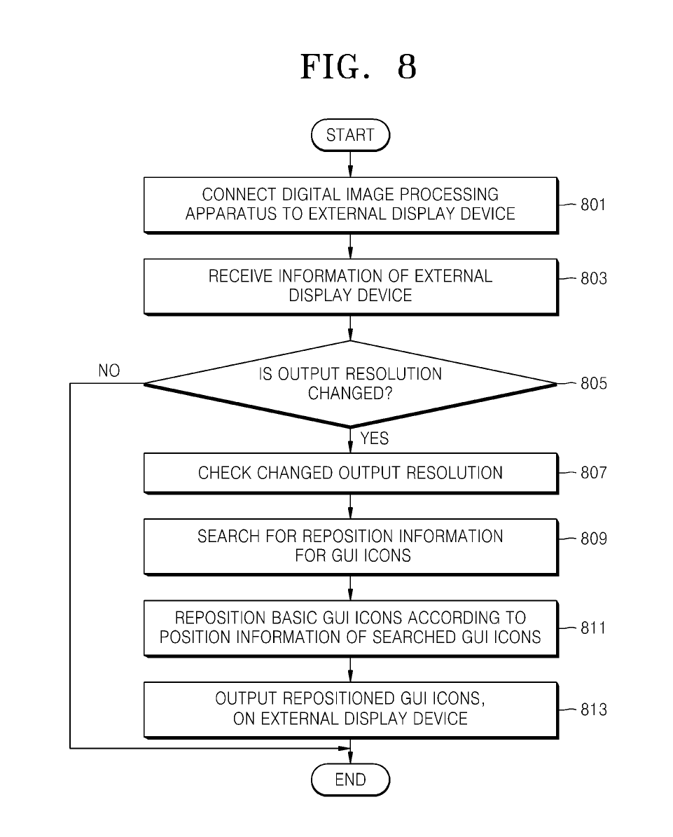

Hereinafter, a method of displaying a GUI in a digital image processing apparatus according to embodiments of the invention will be described with reference to FIGS. 8 through 10. The method may be performed inside a digital image processing apparatus as illustrated in FIG. 1. In detail, methods may be performed in the DSP 50 with the help of other elements of the digital image processing apparatus to perform the main method.

First, a method of displaying a GUI according to an embodiment of the invention will be described.

When an external display device is connected to a digital image processing apparatus in operation 801, the DSP 50 receives display information from the external display device (e.g., TV) in operation 803. Examples of the display information received by the DSP 50 are information indicating an output resolution of the external display device (e.g., VGA 640×480), information indicating a manufacturer of the external display device (e.g., S corporation, L corporation), and information indicating broadcasting standards of the external display device (e.g., NTSC, PAL). The DSP 50 receives the display information of the external display device via an image transmission path or another path.

In operation 805, after the DSP 50 receives the display information of the external display device, whether the output resolution of the external display device has changed is determined.

In operation 807, if the output resolution of the GUI has changed, the DSP 50 determines a new size a changed output resolution.

Next, in operation 809, the DSP 50 searches for reposition information for GUI icons, according to the changed output resolution. In the DSP 50, a position data table of the basic GUI icons as illustrated in FIG. 4A, a reposition data table for the GUI icons for when an output resolution of the external display device, for example, VGA(640×480), is different from an output resolution of the digital image processing apparatus, for example, QVGA(320×240), as illustrated in FIG. 4B, a reposition data table for the GUI icons for when a manufacturer of the external display device, for example, L corporation, is different from a manufacturer of the digital image processing apparatus, for example, S corporation, as illustrated in FIG. 4C, and a reposition data table of GUI icons for when a broadcasting standard of the external display device, for example, PAL, is different from a broadcasting standard of the digital image processing apparatus, for example, NTSC, as illustrated in FIG. 4D are stored, and the DSP 50 searches for the stored data tables and checks position information of the GUI icons to be repositioned.

The DSP 50 repositions the GUI icons according to the position information found in operation 811, and outputs the repositioned GUI icons on the external display device in operation 813. If there are two or more data tables corresponding to the received display information, the DSP 50 assigns priorities thereto. For example, when the received display information includes information indicating that the external display device has a VGA output resolution VGA, information indicating that the external display device is manufactured by L corporation, and information indicating that the external display device uses PAL, higher priority may be assigned to the manufacturer and the reposition information in the data table of FIG. 4C may be used for repositioning the GUI icons. The priority is not fixed and may be set according to user.

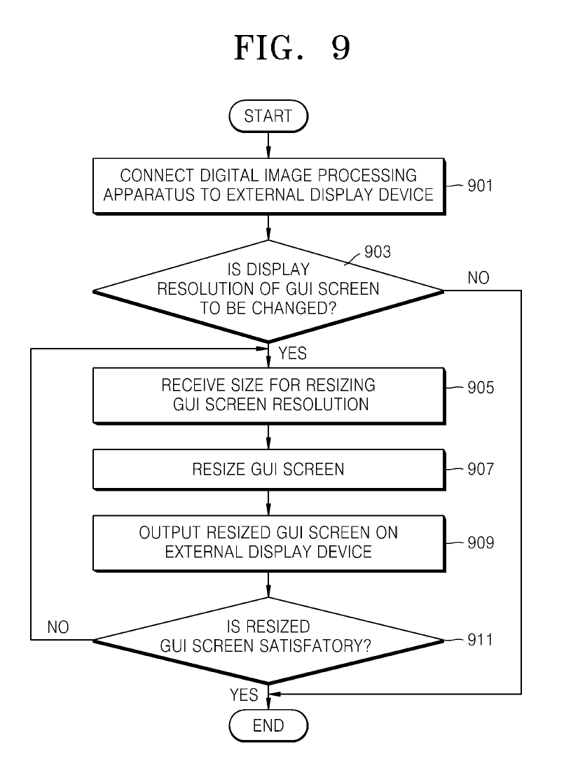

Next, a method of displaying a GUI according to another embodiment of the invention will be described with reference to FIG. 9.

When an external display device is connected to a digital image processing apparatus in operation 901, the DSP 50 determines whether to resize a GUI in operation 903. That is, the user determines whether to resize the GUI according to a selection signal input by the user viewing the GUI displayed on the external display device.

When the user determines to resize the GUI by inputting the selection signal, the DSP 50 receives the signal in operation 905, and resizes the basic GUI in operation 907.

Next, the DSP 50 outputs the resized GUI to the external display device in operation 909. The resized GUI may be moved to a center, a lower right end, or a right side of a screen of the external display device according to selection by the user. In FIG. 6A, a resized GUI 601 is positioned at a lower right end of the screen. In FIG. 6B, the resized GUI 601 is positioned at a right side of the screen. In FIGS. 6C and 6D, the resized GUI screen 601 is positioned at a center of the screen of the external display device.

The DSP 50 inquires the user whether the user is satisfied with the resized GUI displayed on the external display device, and when the user is satisfied, the method is ended, and if not, the method returns to operation 905 to resize the GUI to another size in operation 911.

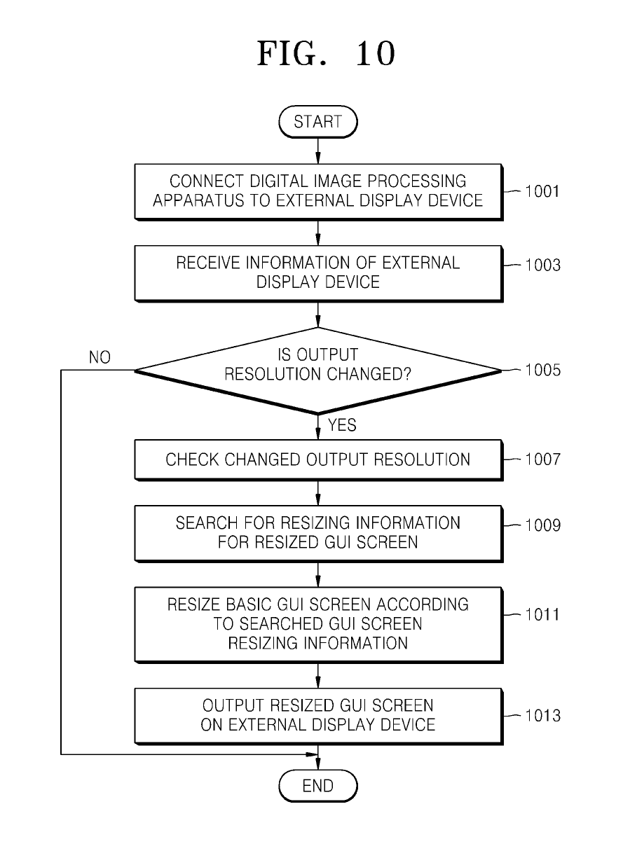

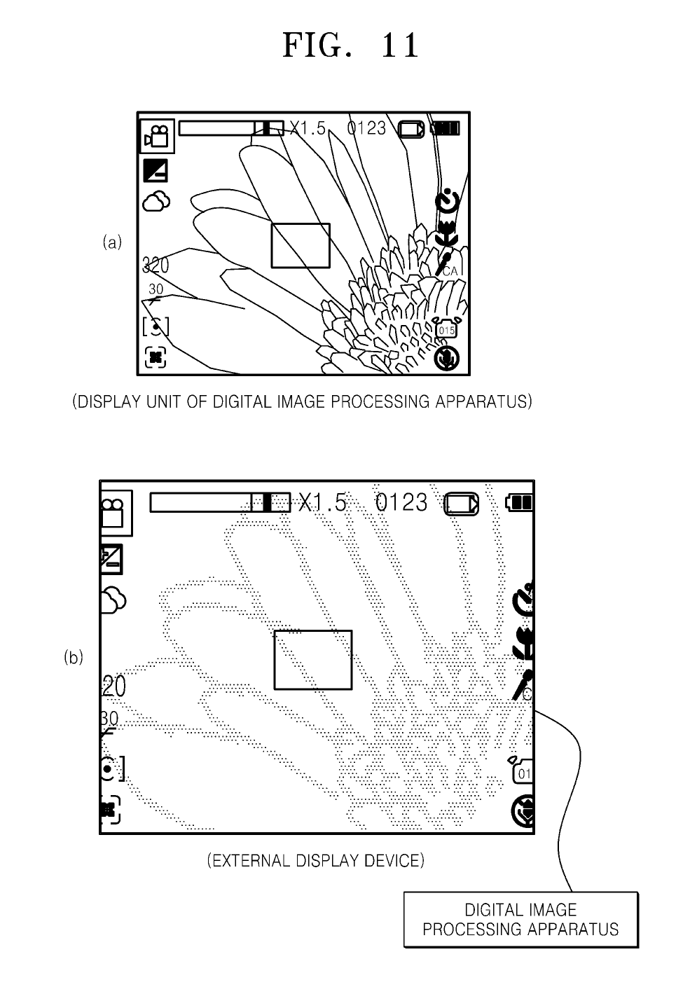

Next, a method of displaying a GUI according to another embodiment of the invention will be described with reference to FIG. 10.

When an external display device is connected to a digital image processing apparatus in operation 1001, the DSP 50 receives display information from the external display device (e.g., TV) in operation 1003. Examples of the display information received by the DSP 50 include information indicating an output resolution, information indicating a manufacturer, information indicating broadcasting standards, or the like. The DSP 50 receives the display information of the external display device via an image transmission path or another path.

In operation 1005, after the DSP 50 receives display information of the external display device, whether the output resolution of the external display device has changed is determined.

In operation 1007, when the output resolution of the external display device has changed, the DSP 50 checks the changed output resolution.

Next, in operation 1009, the DSP 50 searches for resizing information for a GUI screen, according to the changed output resolution. Although not illustrated in FIG. 10, basic GUI screen information and GUI resizing information according to at least one piece of display information are stored in the DSP 50.

In operation 1011, the DSP 50 resizes a size of the basic GUI according to GUI resizing information found in operation 1009, and in operation 1013, outputs the resized GUI to the external display device. If at least two pieces of the GUI screen resizing information corresponding to the received display information exist, the DSP 50 sets a priority. For example, when the received display information are information indicating an output resolution VGA, information indicating L corporation, and information indicating PAL, a priority is set on the manufacturer (L corporation), and a GUI screen is resized according to resizing information corresponding to the L corporation. The priority is not fixed and may be set according to the user.

Also, the DSP 50 repositions the GUI screen in response to a position adjustment signal input by the user. The resized GUI screen may be moved to a center, a lower right end, or a right side of a screen of the external display device.

As described above, according to embodiments of the invention, a position of a GUI or a size of a GUI screen is changed according to external display devices connected to a digital image processing apparatus and output, thereby showing an improved state for a GUI according to an external output.

Also, cropping part of a GUI (or cutting off part of the GUI) due to differences in visible areas despite the same output resolution may be prevented. The differences in visible areas may be due to different manufactures manufacturing the display devices with different specifications. This means that an improved visible area may be provided according to a resolution selected by the user.

The functionality associated with describing embodiments of the invention is described with a number of illustrative units. However, the units may be differently arranged so that the functionality of a single unit may be implemented with two or more units and the functionality of two or more units may be combined into a single unit. Moreover, the functionality may be differently arranged between illustrative units.

The various illustrative units, logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

While embodiments of the invention are particularly shown and described with reference to preferred embodiments thereof, it will be understood by those skilled in the art that various changes in form and details may be made therein without departing from the spirit and scope of the invention as defined by the appended claims. The example embodiments should be considered in descriptive sense only and not for purposes of limitation. Therefore, the scope of the invention is defined not by the detailed description of the invention but by the appended claims, and all differences within the scope will be construed as being included in the invention.

What is claimed is:

1. A digital image processing apparatus, the apparatus comprising:
a graphical user interface (GUI) display device; and
a digital signal processor (DSP) configured to reposition a GUI according to display information received from an external display device and configured to output the repositioned GUI to the external display device,
wherein the digital image processing apparatus is configured to connect to the external display device.

2. The digital image processing apparatus of claim 1, wherein the DSP comprises:
an information receiving unit configured to receive the display information from the external display device;
a storage unit configured to store basic GUI position information and GUI reposition information corresponding to at least one piece of the received display information; and
a control unit configured to search for GUI reposition information corresponding to the received display information stored in the storage unit, and configured to reposition the GUI according to found GUI reposition information, and configured to output the repositioned GUI to the external display device.

3. The digital image processing apparatus of claim 2, wherein the display information of the external display device comprises information indicating a manufacturer of the external display device, information indicating an output resolution of the external display device, and information indicating a broadcasting standard of the external display device.

4. The digital image processing apparatus of claim 3, wherein the control unit is configured to search the storage unit using two or more pieces of the received display information according to priorities assigned thereto to reposition the GUI.

5. A digital image processing apparatus, the apparatus comprising:
a graphical user interface (GUI) display device; and
a digital signal processor (DSP) configured to resize a GUI according to a selection signal received from a user and configured to output the repositioned GUI to the external display device,
wherein the digital image processing apparatus is configured to connect to the external display device.

6. The digital image processing apparatus of claim 5, wherein the DSP comprises:
a resizing unit configured to resize the GUI; and
a control unit configured to control the resizing unit to resize the GUI to fit on the external display device in response to the size adjustment selection signal.

7. The digital image processing apparatus of claim 5, wherein the resized GUI can be positioned in a different position on the external display device.

8. A digital image processing apparatus, the apparatus comprising:
a graphical user interface (GUI) display device; and
a digital signal processor (DSP) configured to resize a GUI according to display information received from the external display device and configured to output the resized GUI to the external display device,
wherein the digital image processing apparatus is configured to connect to the external display device.

9. The digital image processing apparatus of claim 8, wherein the DSP comprises:
an information receiving unit configured to receive display information from the external display device;
a storage unit configured to store basic GUI size information and GUI size change information corresponding to at least one piece of the received display information;
a resizing unit configured to resize the GUI; and
a control unit configured to search in the storage unit for GUI screen size information corresponding to the received display information, and configured to control resizing of the GUI according to GUI size change information, and configured to output the resized GUI to the external display device.

10. The digital image processing apparatus of claim 9, wherein the display information of the external display device comprises information indicating a manufacturer of the external display device, information indicating an output resolution of the external display device, and information indicating a broadcasting standard of the external display device.

11. The digital image processing apparatus of claim 10, wherein the control unit is configured to search the storage unit for two or more pieces of the received display information according to priorities assigned thereto to reposition the GUI.

12. The digital image processing apparatus of claim 9, wherein the resized GUI can be positioned in different places on the external display device.

13. A method of displaying a graphical user interface (GUI) on a digital image processing apparatus, the method comprising:
connecting to an external display device;
receiving display information from the external display device;
searching for GUI reposition information corresponding to the received display information in a storage unit in which is stored GUI position information of the GUI and GUI reposition information corresponding to at least one piece of the display information; and
repositioning the GUI according to found GUI reposition information and outputting the GUI on the external display device.

14. The method of displaying a GUI of claim 13, wherein display information of the external display device comprises information indicating a manufacturer of the external display device, information indicating an output resolution of the external display device, and information indicating a broadcasting standard of the external display device.

15. The GUI display device of claim 13, wherein the control unit searches the storage unit for two or more pieces of the display information according to priorities assigned thereto to reposition the GUI.

16. A method of displaying a graphical user interface (GUI) on a digital image processing apparatus, the method comprising:
connecting to an external display device;
displaying the GUI on the external display device;
receiving a selection signal from a user for resizing the GUI displayed on the external display device; and
resizing the GUI according to the received selection signal and displaying the resized GUI.

17. The method of claim 16, wherein the resized GUI screen can be positioned in different positions on the external display device.

18. A method of displaying a graphical user interface (GUI) on a digital image processing apparatus, the method comprising:
connecting to an external display device;
receiving display information from the external display device;
searching for size information for resizing the GUI corresponding to the received display information; and
resizing of the GUI according to size information for resizing the GUI, and outputting the GUI on the external display device.

19. The method of displaying a GUI on a digital image processing apparatus of claim 18, wherein the received display information of the external display device comprises information indicating a manufacturer, information indicating an output resolution, and information indicating broadcasting standards; and wherein searching further comprises: searching in a storage unit with respect to two or more pieces of the display information according to priorities assigned thereto to reposition the GUI.

20. The method of displaying a GUI on a digital image processing apparatus of claim 19, wherein the resized GUI screen can be positioned in different positions on the external display device.
